(19) United States
(12) Patent Application Publication
(10) Pub. No.: US 2018/0357475 A1
(43) Pub. Date: Dec. 13, 2018

(54) AUTHENTICATION DEVICE AND AUTHENTICATION METHOD

(71) Applicant: SHARP KABUSHIKI KAISHA, Sakai City (JP)

(72) Inventors: DAISUKE HONDA, Sakai City (JP); TAKASHI NAKANO, Sakai City (JP)

(21) Appl. No.: 15/995,808

(22) Filed: Jun. 1, 2018

(30) Foreign Application Priority Data
Jun. 8, 2017 (JP) 2017-113370

(51) Int. Cl. G06K 9/00; G06T 7/62; G06K 9/62

(52) U.S. Cl. CPC G06K 9/00604; G06K 9/00617; G06T 2207/30041; G06K 9/628; G06T 7/62

(57) ABSTRACT

An information processing device includes glare removal unit that generates a second image by removing at least a part of a regularly-reflected light component in an eyeball from a first image of an object acquired by an image pickup apparatus; an iris code generation unit that generates an iris code on the basis of the second image; and a pupil dilation calculation unit that calculates a pupil dilation on the basis of the second image.

### CROSS-REFERENCE TO RELATED APPLICATIONS

This application claims the benefit of priority to Japanese Patent Application Number 2017-113370 filed on Jun. 8, 2017. The entire contents of the above-identified application are hereby incorporated by reference.

### BACKGROUND

The following disclosure relates to an authentication device and the like that carry out iris authentication.

Various personal authentication techniques are recently being developed. An example of such technique is disclosed in JP 2004-167227 A (published Jun. 17, 2004), JP 2006-31103 A (published Feb. 2, 2006), and JP 2004-139259 A (published May 13, 2004).

A personal authentication method pertaining to iris authentication is disclosed in JP 2004-167227 A (published Jun. 17, 2004). Specifically, in this personal authentication method, during registration, data of a registrant is registered in an iris database using feature data found from an iris image and a pupil dilation index obtained. During authentication, whether a subject to be authenticated matches a registrant is determined by referring to the registered data.

A biometric authentication device is disclosed in JP 2006-31103 A (published Feb. 2, 2006). Specifically, this biometric authentication device updates dictionary information, serving as a verification target, by carrying out learning in accordance with verifications results or a learning frequency in a class corresponding to an environment class acquired. The environment class is obtained by measuring environment information when acquiring biological information.

A human authentication device is disclosed in JP 2004-139259 A (published May 13, 2004). Specifically, this human authentication device updates registered information of a target for authentication each time a facial image is verified during a period from a point in time when the registered information of the target for authentication is created or a point in time set by an operator to the present.

### SUMMARY

In iris authentication, authentication errors in which the actual registrant is determined to be “not the registrant”, or someone who is not the registrant is determined to be “the registrant”, can arise depending on the environment. Changes in the size of the pupil, which depends on the intensity of ambient light, when capturing an image of the iris can be given as one cause of such a drop in authentication accuracy.

The size of the pupil changes with the intensity of ambient light. Specifically, the size of the pupil (pupil diameter) decreases as the ambient light brightens. The iris is muscle tissue for changing the size of the pupil, and dilates or contracts in response to intensity of ambient light. Muscle patterns in the iris therefore change depending on the intensity of ambient light. In other words, changes can arise in iris codes used in verification for authentication. In other words, authentication errors such as that described above can arise depending on the ambient light when an image of the iris is captured.

For example, ambient light is relatively less intense indoors, and thus the pupil diameter increases. However, ambient light is relatively more intense outdoors, and thus the pupil diameter decreases. In a case where an iris code is registered on the basis of a result of imaging carried out indoors but authentication is carried out using an iris code acquired on the basis of a result imaging carried out outdoors, the pupil diameters will differ. This causes a change in the iris pattern, i.e., the iris code, leading to the possibility that authentication will fail even when the subject to be authenticated is the actual registrant, for example. In other words, failing to take the size of the pupil into account can result in authentication errors.

According to the technique of JP 2004-167227 A (published Jun. 17, 2004), a plurality of iris codes having different pupil dilation indices are prepared in advance as registered information, and iris authentication that accommodates changes in the size of the pupil depending on the intensity of ambient light can be carried out by selecting an iris code in relation to a pupil dilation index close to the pupil dilation index acquired during the authentication. However, JP 2004-167227 A (published Jun. 17, 2004) makes no mention of reducing glare from ambient light on the eyeball, including the iris and the pupil, which is another cause of reduced authentication accuracy. As such, in a case where such glare is present in the image acquired during authentication or registration, the glare will cause the authentication accuracy to drop.

This is because glare from the ambient light on the eyeball, i.e. ambient light mirror-reflected (regularly reflected) at the surface of the cornea, is captured as part of luminance information of the iris pattern originally intended to be captured. This generates an erroneous iris code.

Meanwhile, according to the technique of JP 2004-167227 A (published Jun. 17, 2004), glare from the ambient light on the eyeball is not removed from the acquired image when finding the pupil dilation index.

Thus, an inaccurate pupil dilation index is calculated in a case where glare from the ambient light is present on the eyeball, and particularly near a boundary separating the pupil and the iris.

This is because the above-mentioned boundary needs to be identified from the image in which the eyeball appears in order to calculate the pupil dilation index, and the wrong location may be identified as the boundary in the case where glare from ambient light is present on the eyeball, and particularly near the above-mentioned boundary. In this case, an inaccurate pupil dilation index is calculated, and authentication errors such as that described above will arise as a result.

Because the technique of JP 2004-167227 A (published Jun. 17, 2004) does not remove the above-mentioned glare when finding the iris code and/or the pupil dilation index, it is thought that accurate authentication is difficult.

Additionally, neither JP 2006-31103 A (published Feb. 2, 2006) nor JP 2004-139259 A (published May 13, 2004) mention reducing the effects of the above-mentioned glare, and thus it is thought that accurate authentication is difficult.

An object of the following disclosure is to realize an authentication device and the like capable of accurate authentication.

To solve the above-described problems, an authentication device according to one aspect of the present disclosure includes: an image information acquiring unit configured to acquire image information of an object including an eyeball; a regularly-reflected light component removal unit configured to remove at least part of a regularly-reflected light component of the eyeball from the image information; an iris code generation unit configured to generate an iris code; and a pupil dilation calculation unit configured to calculate a pupil dilation indicating a degree of dilation of a pupil. Here, (i) the iris code generation unit is configured to generate the iris code, based on post-removal image information obtained by removing at least a part of the regularly-reflected light component, and the pupil dilation calculation unit is configured to calculate the pupil dilation, based on the post-removal image information obtained by removing at least a part of the regularly-reflected light component, or (ii) the iris code generation unit is configured to generate the iris code, based on the post-removal image information obtained by removing at least a part of the regularly-reflected light component, and the pupil dilation calculation unit is configured to calculate the pupil dilation, based on the image information; or (iii) the iris code creation unit is configured to generate the iris code, based on the image information, and the pupil dilation calculation unit is configured to calculate the pupil dilation, based on the post-removal image information obtained by removing at least a part of the regularly-reflected light component.

To solve the above-described problems, an authentication method according to an aspect of the present disclosure includes the steps of: acquiring image information of an object including an eyeball; removing at least a part of a regularly-reflected light component of the eyeball from the image information; generating an iris code; and calculating a pupil dilation indicating a degree of dilation of a pupil. Here, (i) in the step of generating an iris code, the iris code is generated, based on post-removal image information obtained by removing at least a part of the regularly-reflected light component, and in the step of calculating a pupil dilation, the pupil dilation is calculated, based on the post-removal image information obtained by removing at least a part of the regularly-reflected light component; or (ii) in the step of generating an iris code, the iris code is generated, based on the post-removal image information obtained by removing at least a part of the regularly-reflected light component, and in the step of calculating a pupil dilation, the pupil dilation is calculated, based on the image information; or (iii) in the step of generating an iris code, the iris code is generated, based on the image information, and in the step of calculating a pupil dilation, the pupil dilation is calculated, based on the post-removal image information obtained by removing at least a part of the regularly-reflected light component.

According to an aspect of the present disclosure, an effect that accurate iris authentication can be carried out is achieved.

### BRIEF DESCRIPTION OF THE DRAWINGS

The disclosure will be described with reference to the accompanying drawings, wherein like numbers reference like elements.

FIG. 1 is a function block diagram illustrating a primary configuration of an information processing device according to a first embodiment.

FIG. 2 is a diagram for describing a method of calculating pupil dilation.

FIGS. 3A and 3B are diagrams for describing an example of authentication processing carried out by the information processing device of FIG. 1.

FIGS. 4A and 4B are diagrams for describing another example of authentication processing carried out by the information processing device of FIG. 1.

FIGS. 5A and 5B are flowcharts illustrating examples of processing methods carried out by the information processing device according to the first embodiment, where FIG. 5A illustrates an example of a processing method during registration and FIG. 5B illustrates an example of a processing method during authentication.

FIG. 6 is a function block diagram illustrating a primary configuration of an information processing device according to a second embodiment.

FIG. 7 is a flowchart illustrating an example of a processing method carried out by the information processing device according to the second embodiment and an information processing device according to a third embodiment.

FIG. 8 is a function block diagram illustrating a primary configuration of an information processing device according to the third embodiment.

FIGS. 9A and 9B are diagrams illustrating an example of data held in an authentication DB in the information processing device of FIG. 8.

### DESCRIPTION OF EMBODIMENTS

### First Embodiment

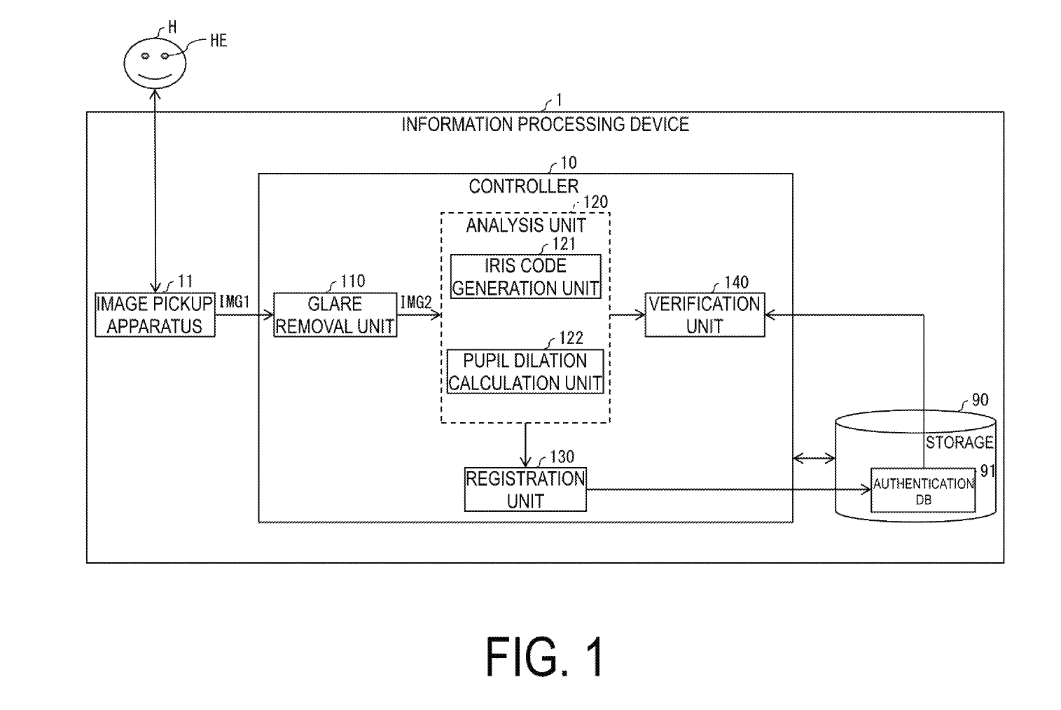

A first embodiment will be described in detail below on the basis of FIGS. 1 to 5B. FIG. 1 is a function block diagram illustrating a primary configuration of an information processing device 1 (an authentication device) according to the first embodiment. As will be described below, the information processing device 1 authenticates an object H using an iris authentication technique.

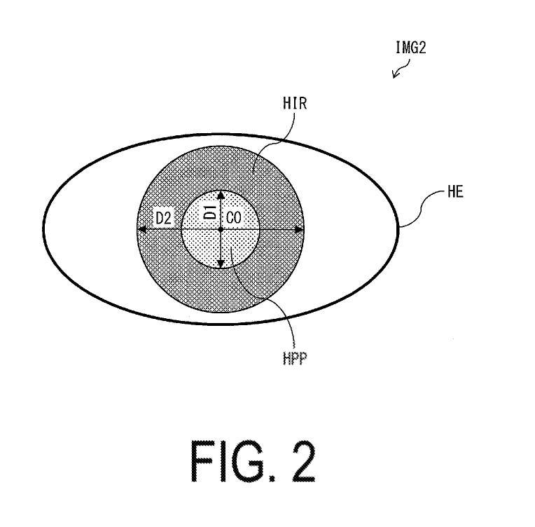

As such, it is assumed that the object H to be authenticated (verified) by the information processing device 1 is an organism having an eyeball HE (see also FIG. 2, described later). The first embodiment describes a case where the object H (the organism) is a person. The authentication by the information processing device 1 is carried out on the basis of a result of analyzing an image of at least one of two eyeballs HE (at least one of the left eye and the right eye) of the object H.

To simplify the descriptions, the first embodiment will describe a case where the object H is authenticated using one of the two eyeballs HE. However, the object H may be authenticated using both of the two eyeballs HE.

### Configuration of Information Processing Device 1

The information processing device 1 includes a controller 10, an image pickup apparatus 11 (an image information acquiring unit), and a storage 90. The controller 10 comprehensively controls various parts of the information processing device 1. The functions of the controller 10 may be realized by a Central Processing Unit (CPU) executing programs stored in the storage 90.

The storage 90 stores various types of programs to be executed by the controller 10 and data used by the programs. For example, an authentication database (DB) 91, which will be described later, is stored in the storage 90.

The image pickup apparatus 11 acquires image information (image data) of the object H by capturing an image of the object H. This image information is information expressing the intensity of light reflected by the object H and received by the image pickup apparatus 11 when capturing an image of the object H, for example. In other words, the image information is information expressing a collection of luminance values in a plurality of pixels included in the image pickup apparatus 11. Put another way, the image information of the object H acquired by the image pickup apparatus 11 (image information of the object H to be supplied to a glare removal unit 110) is information expressing the object H captured by the image pickup apparatus 11 prior to subjecting the image information to various processes (pre-processing), and is thus different from image information displayed in a display unit after the various processes have been carried out. The image information of the object H acquired by the image pickup apparatus 11 is referred to as “first image IMG1” hereinafter. Note that the image information acquired by the image pickup apparatus 11 also includes image information corresponding to the image information prior to being subjected to the various processes described above. For example, a single image generated by combining a plurality of images prior to being subjected to the various processes acquired by the image pickup apparatus 11 may be used as the first image IMG1. In other words, image information obtained by averaging pieces of image information expressing a plurality of images acquired (the image information expressing a single image) may be used as the first image IMG1. That is, the first image IMG1 may be generated using the image information acquired. The image pickup apparatus 11 supplies the first image IMG1 to the controller 10 (and more specifically, to the glare removal unit 110, which will be described below).

As an example, the image pickup apparatus 11 may include (i) a plurality of polarizing elements having mutually-different principle axis directions and (ii) a plurality of image capturing elements. Alternatively, the image pickup apparatus 11 may include (i) a plurality of wavelength selecting elements having wavelength selectivity with respect to different wavelengths (e.g., wavelength filters such as RGB filters) and (ii) a plurality of image capturing elements.

An image (object) expressing the eyeball HE of the object H is included in the first image IMG1. As such, images expressing a pupil HPP and an iris HIR of the eyeball HE are both included in the first image IMG1, in the same manner as a second image IMG2, which will be described later (see also FIG. 2). In other words, the first image IMG1 includes image information expressing both the pupil HPP and the iris HIR. As such, the first image IMG1 may be referred to as an “iris image”.

The controller 10 includes the glare removal unit 110 (a regularly-reflected light component removal unit), an analysis unit 120, a registration unit 130, and a verification unit 140. The analysis unit 120 includes an iris code generation unit 121 and a pupil dilation calculation unit 122.

The glare removal unit 110 removes at least a part of a regularly-reflected light component of the eyeball HE from the first image IMG1. In other words, the glare removal unit 110 removes glare from ambient light on the eyeball HE from the first image IMG1 (the iris image).

The glare removal unit 110 generates the second image IMG2 as an image from which at least a part of the regularly-reflected light component has been removed from the first image IMG1. Specifically, by removing at least some of luminance values expressing the regularly-reflected light component from the luminance values in the image information corresponding to the first image IMG1, the glare removal unit 110 generates image information (post-removal image information) as the second image IMG2. The second image IMG2 is an image from which glare from ambient light has been removed, and may thus be referred to as a “glare-removed image”. The glare removal unit 110 supplies the second image IMG2 to the analysis unit 120 (to both the iris code generation unit 121 and the pupil dilation calculation unit 122).

The glare removal unit 110 may use the following method as a method for removing the glare of ambient light (referred to as a “glare removal method” hereinafter).

As an example, the glare removal method disclosed in “JP 395516 B” may be used. In this case, the image pickup apparatus 11 includes an image capturing element and a polarizing element. An angle of the principle axis of the polarizing element is varied by rotating the polarizing element. The glare removal unit 110 takes a group of pixels, in which mirror reflection is present, in a plurality of the first images IMG1, acquired by the image capturing element and having mutually-different principle axes of the polarizing element, and identifies an incidence surface and an incident angle from a normal vector and a line-of-sight vector of the object H for each pixel in the group of pixels. The glare removal unit 110 forms a pixel cluster by clustering pixels in which both the incidence surface and the incident angle are similar, and separates reflection components for that pixel cluster by assuming a stochastic independence between diffused reflection components and mirror reflection components. The glare removal unit 110 can therefore remove a mirror reflection component from the first image IMG1.

Meanwhile, in a case where the image capturing element is an element in which single pixel units, associated with a plurality of polarizing elements having mutually-different principle axis directions, are arranged two-dimensionally, the glare removal unit 110 may calculate or estimate a minimum value of the luminance (a minimum luminance value) for each pixel unit associated with the eyeball HE in the first image IMG1, and then remove at least a part of the regularly-reflected light component at the surface of the eyeball HE in the first image IMG1 on the basis of the minimum luminance value.

Note that the glare removal unit 110 may carry out Independent Component Analysis (ICA) to remove at least a part of the regularly-reflected light component.

Alternatively, the glare removal unit 110 may employ a glare removal method that uses color features, disclosed in literature: “The Measurement of Highlights in Color Images” by Gudrun J. Klinker, Steven A. Shafer, and Takeo Kanade.

The analysis unit 120 generates various data used for iris authentication by analyzing the second image IMG2. In the analysis unit 120, the iris code generation unit 121 generates an iris code to be used for iris authentication on the basis of the second image IMG2. A known method (e.g. the methods disclosed in JP 2004-167227 A (published Jun. 17, 2004) or JP 2004-139259 A (published May 13, 2004)) may be used in the generation of the iris code by the iris code generation unit 121.

In the analysis unit 120, the pupil dilation calculation unit 122 calculates the pupil dilation on the basis of the second image IMG2. “Pupil dilation” is an indicator of indicating a degree of dilation of the pupil (the degree to which the pupil is open). The pupil dilation calculated by the pupil dilation calculation unit 122 is referred to as a “pupil dilation R” hereinafter.

FIG. 2 is a diagram for describing a method of calculating the pupil dilation R. FIG. 2 schematically illustrates the eyeball HE expressed by the second image IMG2. As illustrated in FIG. 2, the second image IMG2 includes images expressing both the pupil HPP and the iris HIR of the eyeball HE. Hereinafter, in the second image IMG2, (i) a region including the pupil HPP is referred to as a “pupil region”, and (ii) a region including the iris HIR is referred to as an “iris region”.

Here, the diameter of the pupil HPP is represented by D1. In a case where the pupil HPP is circular, D1 is may be the diameter of the pupil HPP. However, in a case where a perfectly circular image of the pupil HPP cannot be obtained because of the pupil HPP being partially covered by a foreign object (e.g., an eyelash), and the like, the pupil dilation calculation unit 122 may use circular fitting on the pupil HPP in the second image IMG2. The pupil dilation calculation unit 122 may calculate D1 for the pupil HPP after the circular fitting. The same applies to an outer diameter D2, which will be mentioned later.

The circular fitting is preferably carried out on the second image IMG2 (the post-glare removal image), as described in the first embodiment. However, the circular fitting may be carried out on the first image IMG1 (the pre-glare removal image).

For the sake of simplicity, a case where the iris HIR is a circle like the pupil HPP is considered. In FIG. 2, to simplify the descriptions, it is assumed that the iris HIR shares a center C0 with the pupil HPP. In other words, the iris HIR and the pupil HPP are assumed to be concentric. However, the iris HIR and the pupil HPP need not be concentric.

The iris HIR has a larger outer diameter than the pupil HPP. The outer diameter of the iris HIR is represented by D2 below. As illustrated in FIG. 2, the diameter D1 of the pupil HPP is equal to the inner diameter of the iris HIR. In other words, the diameter D1 can also be expressed as the inner diameter of the iris HIR.

The diameter D1 of the pupil HPP may be expressed as a pupil region length in the pupil region. The “pupil region length” is a length, along a straight line passing through the center C0 of the pupil region, between the ends of the pupil region. Likewise, the outer diameter D2 of the iris HIR may be expressed as an iris region length in the iris region. The “iris region length” is a length, along a straight line passing through the center of the iris region, between the ends of the iris region. In the case of FIG. 2, the iris region length is a length, along a straight line passing through the center C0 of the pupil region, between the ends of the iris region.

The pupil dilation calculation unit 122 calculates the pupil dilation R as R=D1/D2, for example. In other words, the pupil dilation calculation unit 122 calculates the pupil dilation R as a ratio (percentage) of the diameter D1 of the pupil HPP (the inner diameter of the iris HIR; the pupil region length) to the outer diameter D2 of the iris HIR (the iris region length).

Although FIG. 2 illustrates a case where both the pupil HPP and the iris HIR are circles (or a case where circular fitting has been carried out), the pupil HPP and the iris HIR are actually elliptical in shape. As such, in a case where the pupil HPP, for example, is handled as being elliptical in shape, either the length of the long axis of the pupil HPP or the length of the short axis of the pupil HPP may be used as the diameter D1 of the pupil HPP. The same applies to the iris HIR as well.

Furthermore, the method of calculating the pupil dilation R (the calculation formula) is not limited to that described above, and any desired method may be used. As an example, the pupil dilation calculation unit 122 may use the diameter D1 of the pupil HPP itself as the pupil dilation R. The diameter (inner diameter) D1 and the outer diameter D2 may also be calculated using any desired methods.

However, in a case where the distance between the image pickup apparatus 11 and the object H (an image capturing distance) can change, it is preferable that the pupil dilation R be calculated as R=D2/D1. This is because in the case where the image capturing distance changes, that change in the image capturing distance will cause the sizes of the pupil HPP and the iris HIR in the second image IMG2 to vary.

Thus, even in a case where the image capturing distance varies, changes in the pupil dilation R caused by the variations in the image capturing distance can be canceled out by calculating the pupil dilation R using the ratio of the diameter D1 of the pupil HPP to the outer diameter D2 of the iris HIR. This makes it possible to calculate the pupil dilation R with a higher level of accuracy.

The analysis unit 120 supplies the iris code (the result of the analysis by the iris code generation unit 121) and the pupil dilation R (the result of the analysis by the pupil dilation calculation unit 122) to the registration unit 130 or the verification unit 140.

The registration unit 130 registers (writes) the iris code and pupil dilation R acquired from the analysis unit 120 in the authentication DB 91 of the storage 90. The authentication DB 91 is a database in which various types of data for carrying out iris authentication on the object H are stored. The present embodiment assumes that an iris code and a pupil dilation registered for the object H in advance (hereinafter “registered iris code” and a “registered pupil dilation”, respectively) are already recorded in the authentication DB 91.

More specifically, the registration unit 130 relates (associates) the iris code and the pupil dilation R acquired from the analysis unit 120 and registers these in the authentication DB 91 as the registered iris code and the registered pupil dilation. In other words, the registration unit 130 registers the registered iris code and the registered pupil dilation as a set (a registered data pair) in the authentication DB 91. The registration unit 130 may register the registered iris code and the registered pupil dilation in association with a user (a registrant; described later). In this case, the controller 10 acquires information indicating the user (registrant information) when the first image IMG1 is acquired.

By providing the registration unit 130, each time data for iris authentication is generated by the analysis unit 120, that data can be registered in the authentication DB 91 as new data.

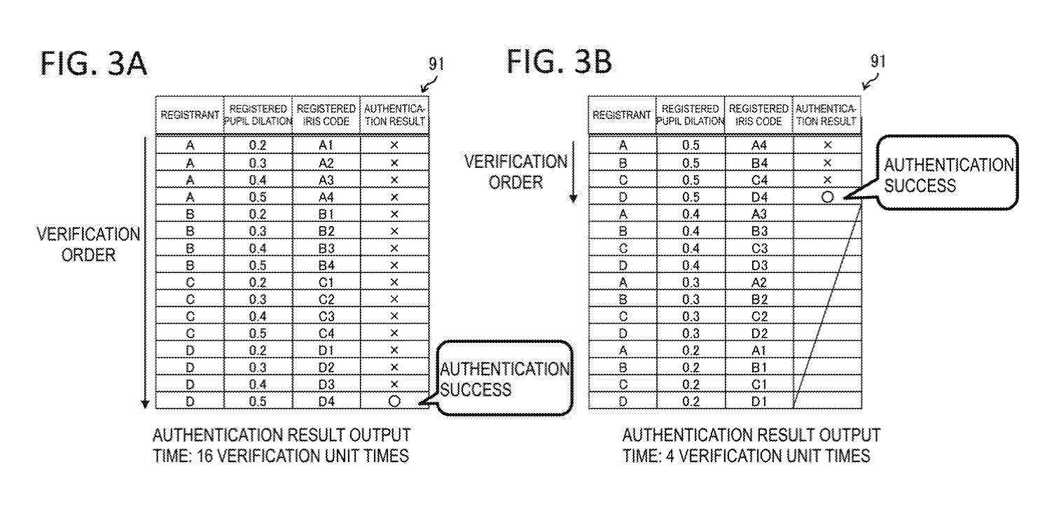

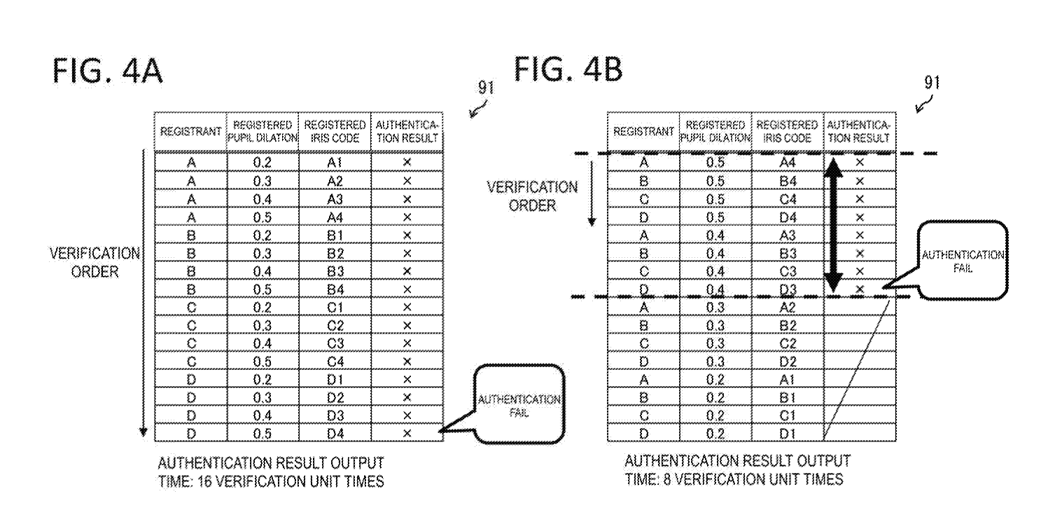

A plurality of registered data pairs having different pupil dilations may be registered in the authentication DB 91 for each user (see also FIGS. 3A to 4B, which will be described later).

### Example of Authentication Processing by Information Processing Device 1

The verification unit 140 carries out iris authentication for the object H using the iris code and pupil dilation R acquired from the analysis unit 120. Specifically, the verification unit 140 verifies the iris code and the pupil dilation R against a registered iris code and a registered pupil dilation, respectively, already registered in the authentication DB 91. More specifically, the verification unit 140 carries out the verification by carrying out a first step and then a second step, both described below.

First step: extracting registered iris codes associated with a corresponding plurality of registered pupil dilations in order from the code for which the values of the registered pupil dilation and the pupil dilation R are the closest. As an example, assuming the registered pupil dilation is represented by R0, the registered iris codes may be extracted in order from the code for which ΔR=|R0−R| is the lowest.

However, the method of extracting the registered iris codes in the first step is not limited to a method that uses ΔR. In the first step, it is sufficient that the registered iris codes be extracted in order from the code for which the values of the registered pupil dilation and the pupil dilation R are the closest.

Second step: verifying the iris code against the registered iris codes extracted in the first step, in order from the code for which the values of the registered pupil dilation and the pupil dilation R are the closest (e.g., in order from the code for which ΔR is the lowest).

A known method may be used as the method for verifying the iris code against the registered iris codes in the second step. For example, the verification unit 140 may calculate a Hamming distance Hd between each registered iris code and the iris code and carry out the verification on the basis of the Hamming distance Hd. Specifically, the verification unit 140 determines that the coincidence between a registered iris code and an iris code is within a prescribed range in a case where the Hamming distance Hd is less than or equal to a prescribed Hamming distance threshold Hdth. In this case, the verification unit 140 determines that the iris authentication for the object H has succeeded. On the other hand, in a case where the coincidence is outside the prescribed range (in a case where the Hamming distance Hd is greater than the Hamming distance threshold Hdth), the verification unit 140 determines that the iris authentication has failed. In other words, the coincidence can be said to be high in a case where the Hamming distance Hd is less than or equal to the Hamming distance threshold Hdth, whereas the coincidence can be said to be low in a case where the Hamming distance Hd is greater than the Hamming distance threshold Hdth.

### First Example

As an example, consider a case where a registered iris code and a registered pupil dilation are registered in the authentication DB 91 for each of four people, namely registrants A to D. FIGS. 3A and 3B are diagrams for describing an example of authentication processing. The example illustrated in FIGS. 3A and 3B will also be referred to as a “first example”. The first example is an example in which authentication is carried out for the registrants and the authentication succeeds.

Consider a case where four registered pupil dilations, namely 0.20, 0.30, 0.40, and 0.50, are registered for registrants A to D, respectively, as illustrated in FIGS. 3A and 3B.

Furthermore, assume that four registered iris codes are registered for each of registrants A to D. Specifically, four registered iris codes A1 to A4 are registered for registrant A; four registered iris codes B1 to B4 are registered for registrant B; four registered iris codes C1 to C4 are registered for registrant C; and four registered iris codes D1 to D4 are registered for registrant D.

The numbers appended to the registered iris codes are assumed to be assigned in order from the lowest registered pupil dilation. Thus, for example, for registrant A, registered iris code A1 corresponds to a registered pupil dilation of 0.20. Likewise, registered iris code A4 corresponds to a registered pupil dilation of 0.50. The same applies to registrants B to D.

Although the registered iris codes are expressed as text such as “A1” in FIGS. 3A and 3B for the sake of simplicity, it should be noted that each registered iris code is actually a multi-bit (e.g., 2048-bit) digital signal. Also for the sake of simplicity, the following will describe an example where the personal authentication of the object H succeeds when his/her iris code is a perfect match with a registered iris code. However, in reality, there is an extremely low chance of a multi-bit registered iris code matching an iris code perfectly. Thus, it should be noted that the registered iris code and the iris code do not actually need to match perfectly for the personal authentication of the object H to succeed as described above.

Here, consider a case where the information processing device 1 captures an image of registrant D as the object H, and the pupil dilation R acquired from the analysis unit 120 is 0.50. This assumes that the iris code acquired from the analysis unit 120 is “D4”.

FIG. 3A illustrates the authentication DB 91 when the above-described first step and second step are not carried out (the data is not rearranged). In FIG. 3A, the data is arranged in order from registrant A, to B, to C, and then finally to D. Additionally, for each individual registrant (e.g., registrant A), the data is arranged in order from the lowest registered pupil dilation (from a registered pupil dilation of 0.20, to 0.30, to 0.40, and finally to 0.50).

Accordingly, in FIG. 3A, the first data is “registered iris code A1, registered pupil dilation 0.20”. The last data (16th data) is “registered iris code D4, registered pupil dilation 0.50”.

In this case, the verification unit 140 verifies the iris code against the registered iris codes in order from the first data, to the second data, and so on to the 15th data, and finally to the 16th data. Thus, the verification unit 140 successfully authenticates registrant D (the object H) (the object H is confirmed as registrant D) in the 16th instance of verification.

The time required for a single authentication (and more specifically, the time required to output a single authentication result) is referred to as “one verification unit time”. In the example of FIG. 3A, authenticating registrant D takes 16 verification unit times.

On the other hand, FIG. 3B illustrates the authentication DB 91 after the above-described first step and second step have been carried out on the authentication DB 91 illustrated in FIG. 3A (after the data has been rearranged).

In this case, in the first step, the verification unit 140 extracts the registered iris codes in order from the code for which the values of the registered pupil dilation and the pupil dilation R (0.50) are the closest. As a result, the data is arranged in order from the data in which the registered pupil dilation is closest to 0.50, in order from registrants A to D, as illustrated in FIG. 3B. Thus, in FIG. 3B, the data “registered iris code A4, registered pupil dilation 0.50” becomes the first data, and “registered iris code D4, registered pupil dilation 0.50” becomes the fourth data. The last data (16th data) becomes “registered iris code D1, registered pupil dilation 0.20”.

Next, in the second step, the verification unit 140 verifies the iris code against the registered iris codes in order from the first data, to the second data, and so on. Thus, the verification unit 140 successfully authenticates registrant D (the object H) in the fourth instance of verification. In other words, the verification unit time required to authenticate the registrant D in the example of FIG. 3B can be reduced to four verification unit times.

Note that the verification unit 140 may end the authentication process at the point in time when the object H is successfully authenticated (when the object H is confirmed to be a specific one of registrants A to D).

By verifying the iris code against the registered iris codes in order from the code for which ΔR is the lowest, the time required for authentication (the time from when the first image IMG1 is acquired to when the authentication result is output) can be shortened compared to a case where the verification is performed randomly.

The verification unit 140 may announce the authentication result indicating whether the iris authentication has succeeded or failed for the object H to the user by presenting the authentication result through a presenting device (not illustrated). A display device, a speaker, and the like that can be communicably connected to the information processing device 1 can be given as examples of the presenting device. The information processing device 1 may also include the presenting device.

A range of ΔR for determining the above-described coincidence (the coincidence being within a prescribed range) may be set in advance to shorten the time required for the iris authentication. In this case, the verification unit 140 may determine that the iris authentication has failed in a case where the above-described coincidence cannot be determined to be in a range where ΔR is less than or equal to a prescribed value. A second example below describes an example of such a process.

### Second Example

The second example will be described next with reference to FIGS. 4A and 4B. FIGS. 4A and 4B are diagrams for describing another example of authentication processing. The second example is an example in which authentication is carried out for a non-registrant and the authentication fails. A case where the information processing device 1 has captured a non-registrant E as the object H, and the pupil dilation R acquired from the analysis unit 120 is 0.50 is considered in the second example. This assumes that the iris code acquired from the analysis unit 120 is “E4”.

FIG. 4A illustrates the same authentication DB 91 as that in FIG. 3A. In the second example too, the verification unit 140 verifies the iris code against the registered iris codes in order from the first data, to the second data, and so on to the 15th data, and finally to the 16th data. Thus, it takes 16 verification unit times until the verification unit 140 determines that the authentication of non-registrant E (the object H) has failed.

FIG. 4B illustrates the same authentication DB 91 as that in FIG. 3B. In FIG. 4B, it is assumed that a range has been set in advance for ΔR, namely, ΔR≤0.1. In this case, the verification unit 140 carries out the verification only for data in which ΔR=0 or ΔR=0.1. Specifically, the verification unit 140 verifies the iris code against the registered iris codes in order from the first data, to the second data, and so on to the seventh data, and finally to the eighth data. Thus, it takes eight verification unit times until the verification unit 140 determines that the authentication of non-registrant E (the object H) has failed. In this manner, the time required for iris authentication can be shortened by setting a range of ΔR for determining the above-described coincidence in advance.

Note that in a case where, as an example, the value of R (the pupil dilation) differs greatly from the registered pupil dilation, the Hamming distance Hd will increase and the authentication accuracy will drop, even when verifying the actual registrant. Thus, even in a case where the authentication is retried with the same registered pupil dilation and registered iris code after determining that the authentication has failed, it is assumed to be even less likely that the authentication will be carried out correctly.

Accordingly, it is preferable that the range of ΔR for determining the above-described coincidence be set in advance as described above even when verifying a registrant. In a case where the time required for iris authentication is shortened, a registrant verification failure can be confirmed in a shorter amount of time, and a first image IMG1 can be captured again quickly to retry the authentication. The authentication may then be carried out again with the registered pupil dilation and registered iris code newly obtained when the first image IMG1 is captured again (a new first image may be captured and the authentication may be retried).

### Processing Method by Information Processing Device 1

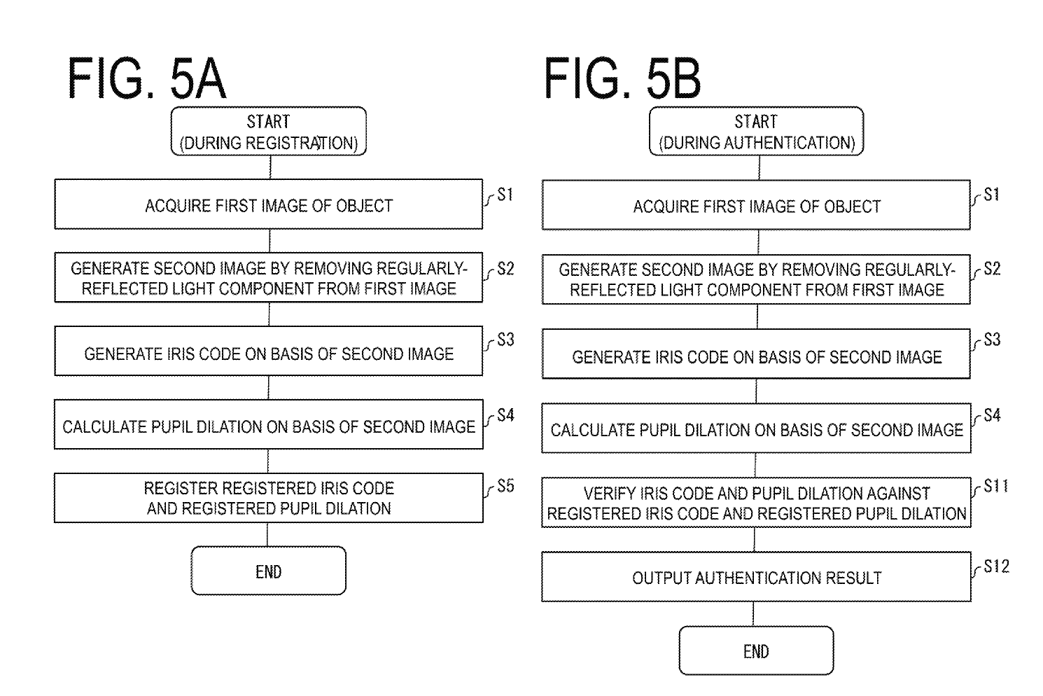

An example of a processing method (authentication method) carried out by the information processing device 1 will be described with reference to FIGS. 5A and 5B. FIGS. 5A and 5B are flowcharts illustrating examples of processing methods carried out by the information processing device 1, where FIG. 5A illustrates an example of a processing method during registration and FIG. 5B illustrates an example of a processing method during authentication.

### Processing During Registration

In the information processing device 1, the image pickup apparatus 11 acquires the first image IMG1 of the object H by capturing an image of the object H (step S1; a step of acquiring image information). The image pickup apparatus 11 supplies the first image IMG1 acquired to the glare removal unit 110. Note that in step S1, or as a step prior to step S1, the controller 10 may receive the above-described registrant information input by the user.

The glare removal unit 110 then generates the second image IMG2 by removing at least a part of the regularly-reflected light component from the first image IMG1 (step S2; a step of removing a regularly-reflected light component). Glare from ambient light can be removed from the first image IMG1 as a result. The glare removal unit 110 supplies the second image IMG2 generated to the analysis unit 120.

In the analysis unit 120, the iris code generation unit 121 generates the iris code on the basis of the second image IMG2 (step S3; a step of generating an iris code). Once this process ends, the iris code generation unit 121 supplies the iris code generated to the registration unit 130. Additionally, in the analysis unit 120, the pupil dilation calculation unit 122 calculates the pupil dilation R on the basis of the second image IMG2 (step S4; a step of calculating a pupil dilation). Once this process ends, the pupil dilation calculation unit 122 supplies the pupil dilation R calculated to the registration unit 130. Note that the processes of steps S3 and S4 may be carried out in parallel or in the reverse order.

The registration unit 130 relates the iris code generated and the pupil dilation R calculated and registers these in the authentication DB 91 of the storage 90 as the registered iris code and the registered pupil dilation, respectively (step S5). In a case where the registrant information is acquired, the registration unit 130 registers that registrant information in relation to the registered iris code and the registered pupil dilation.

### Processing During Authentication

The above-described processes of steps S1 to S4 are also carried out during authentication. However, unlike the processing during registration, the user registration is not carried out in step S1 or as a step prior thereto. Furthermore, the iris code generated and the pupil dilation R calculated are supplied to the verification unit 140 in steps S3 and S4, respectively.

The verification unit 140 verifies the iris code and pupil dilation R supplied (i.e., the iris code and pupil dilation R based on the object H captured during authentication) against the registered iris code and the registered pupil dilation, respectively (step S11). The registered iris code and the registered pupil dilation are the data registered in the above-described processing carried out during registration.

As described above, the verification unit 140 determines, for example, in order from the iris code for which the values of the pupil dilation R and registered pupil dilation supplied are the closest, whether the Hamming distance Hd between the iris code and the registered iris code respectively in relation to the dilations is less than or equal to the Hamming distance threshold Hdth.

In a case where the Hamming distance Hd is less than or equal to the Hamming distance threshold Hdth, the verification unit 140 determines that the iris authentication for the object H has succeeded. However, in a case where the Hamming distance Hd is greater than the Hamming distance threshold Hdth, the verification unit 140 determines that the iris authentication for the object H has failed. Then, the verification unit 140 announces the result of the iris authentication to the user by outputting that result through the presenting device (step S12).

### Effects of Information Processing Device 1

According to the information processing device 1, iris codes (registered iris codes) can be registered one at a time in association with a plurality of different pupil dilations (registered pupil dilations) for each user (see FIGS. 3A to 4B, described above). Thus, it is possible to carry out authentication using a registered pupil dilation having a value close to the pupil dilation R obtained during authentication, and thus the authentication accuracy can be improved.

Additionally, according to the information processing device 1, analyzing the second image IMG2 (an image obtained by removing at least a part of the regularly-reflected light component from the first image IMG1; the glare-removed image) makes it possible to acquire the iris code and pupil dilation R of the object H more accurately.

As such, even in a case where glare from ambient light on the iris HIR is present in the first image IMG1, the second image IMG2, in which the glare has been removed, can be used for the analysis by the analysis unit 120. Thus, it is possible to acquire the iris code and the pupil dilation R after the glare has been removed. As a result, the accuracy of the verification by the verification unit 140 (the iris authentication) can be improved beyond the related art.

In other words, the information processing device 1 can solve the above-described problems. As described above, changes in the size of the pupil, which depends on the intensity of ambient light, when capturing an image of the iris can be given as one cause of a drop in authentication accuracy. Such changes can cause changes in the pupil dilation or the iris code. Registering iris codes in association with a plurality of different pupil dilations for each user, and then selecting the iris code associated with the pupil dilation closest to the pupil dilation acquired during authentication can be considered as a way to suppress a drop in authentication accuracy caused by such changes. However, unless measures are taken to reduce glare from ambient light on the eyeball, which is another cause of a drop in authentication accuracy, an accurate pupil dilation cannot be calculated. As a result, the authentication accuracy drops due to such glare, even in the case where authentication is carried out using the pupil dilation. An iris code affected by such glare is also be generated unless such measures are taken for the iris code as well, which will cause a drop in the authentication accuracy. According to the information processing device 1, the iris code and the pupil dilation R are acquired using the second image IMG2 from which glare has been removed, as described above. This makes it possible to suppress a drop in the authentication accuracy. Accurate iris authentication can therefore be carried out in a variety of environments.

Furthermore, according to the information processing device 1, verification can be carried out in order from the registered pupil dilation having a value closest to the pupil dilation R. Thus, it is possible to shorten the time required for authentication (see FIG. 3B, described above).

Further still, setting a range of ΔR for determining the coincidence as described above makes it possible to reduce the time required for authentication (see FIG. 4B, described above).

Additionally, according to the information processing device 1, an iris code and a pupil dilation based on the second image IMG2, from which the glare has been removed, are registered (accumulated). Thus, during the verification, it is not necessary to carry out processing equivalent to glare removal on the iris code and pupil dilation acquired (e.g. processing for generating the second image IMG2 and generating the iris code based on the second image IMG2, and processing for calculating the pupil dilation R) each time to register the iris code and the pupil dilation. Thus, it is possible to effectively shorten the time required for authentication.

### ADDITIONAL NOTES

Although the present embodiment describes the information processing device 1 as including the above-described elements in an integrated manner, the device is not limited thereto. For example, the information processing device 1 need not include the image pickup apparatus 11, nor the storage 90. In this case, the image pickup apparatus 11 and the storage 90 may be provided as devices external to the information processing device 1 and communicably connected to the information processing device 1.

Additionally, the information processing device 1 need not include, for example, the registration unit 130 and verification unit 140 as functions for the iris authentication on the object H. In this case too, the registration unit 130 and the verification unit 140 may be provided as devices external to the information processing device 1 and communicably connected to the information processing device 1.

In other words, it is sufficient for the information processing device 1 to include the glare removal unit 110 and the analysis unit 120 as the basic configuration for realizing accurate iris authentication.

### MODIFICATION

As described above, in the first embodiment, the analysis unit 120 generates the iris code on the basis of the second image IMG2 generated by the glare removal unit 110, and then calculates the pupil dilation. However, the configuration is not limited thereto, and the information processing device 1 according to a variation may include the following configuration (i) or (ii).

(i) The iris code creation unit 121 generates the iris code on the basis of the second image IMG2, and the pupil dilation calculation unit 122 calculates the pupil dilation on the basis of the first image IMG1. In this case, the pupil dilation calculation unit 122 acquires the first image IMG1 from the image pickup apparatus 11. The method of calculating the pupil dilation is the same as the processing for the second image IMG2.

In this case, the influence of the glare is reduced at least for the iris code, which makes it possible to carry out the authentication more accurately than when the influence of the glare is not taken into account (when the first image IMG1 is used for the iris code as well).

(ii) The iris code generation unit 121 generates the iris code on the basis of the first image IMG1, and the pupil dilation calculation unit 122 calculates the pupil dilation on the basis of the second image IMG2. In this case, the iris code generation unit 121 acquires the first image IMG1 from the image pickup apparatus 11. The method of generating the iris code is the same as the processing for the second image IMG2.

In this case, the influence of the glare is reduced at least for the pupil dilation, which makes it possible to carry out the authentication more accurately than when the influence of the glare is not taken into account (when the first image IMG1 is used for the pupil dilation as well). In other words, authentication errors caused by the pupil dilation being inaccurate can be reduced.

A second embodiment and a third embodiment will describe examples in which the analysis unit 120 generates the iris code on the basis of the second image IMG2 generated by the glare removal unit 110, and calculates the pupil dilation, but it should be noted that the above-described configurations (i) and (ii) can also be applied in those embodiments.

### Second Embodiment

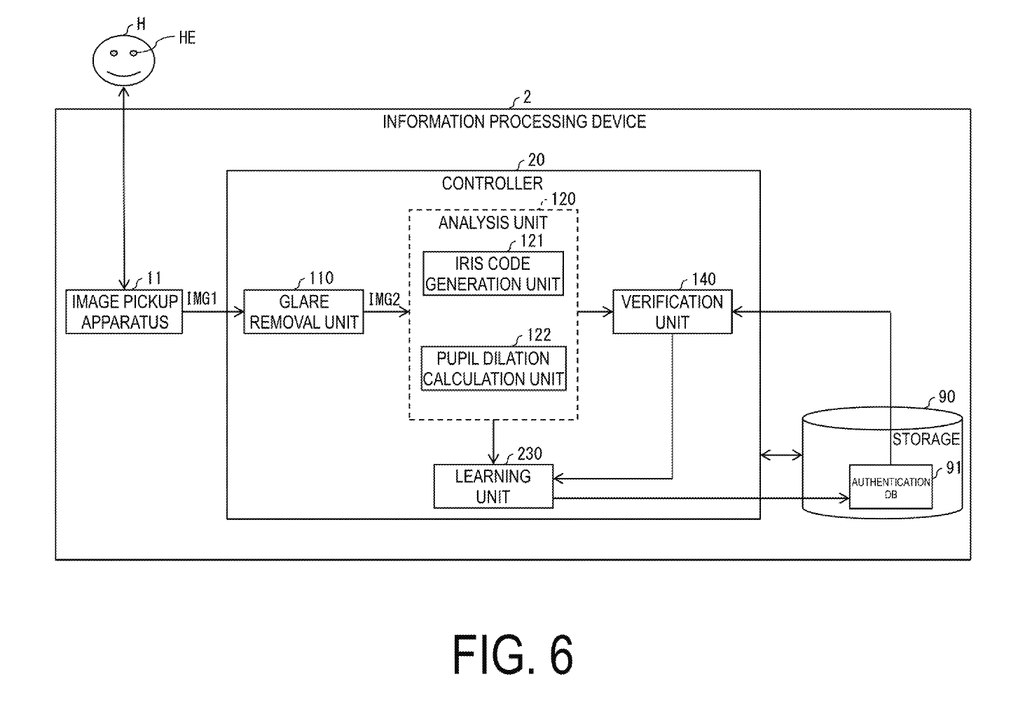

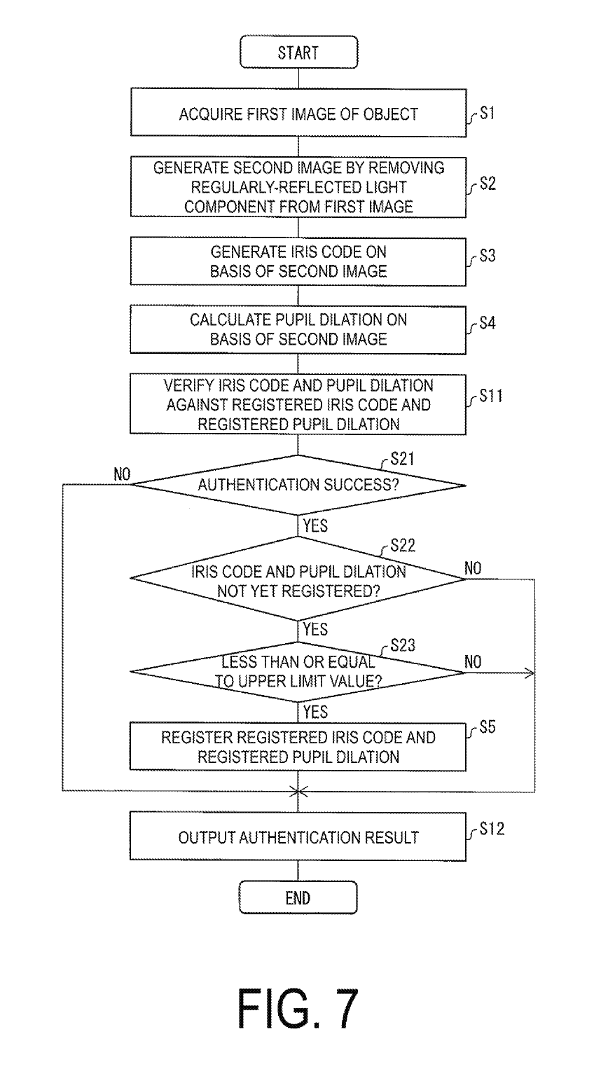

The second embodiment will be described next with reference to FIGS. 6 and 7. Note that for the sake of simplicity, elements having the same functions as elements described in the foregoing embodiment will be assigned the same reference signs, and descriptions thereof will be omitted.

### Configuration of Information Processing Device 2

FIG. 6 is a function block diagram illustrating a primary configuration of an information processing device 2 (an authentication device) according to the second embodiment. The information processing device 2 has a configuration in which the registration unit 130 of the information processing device 1 in the first embodiment has been replaced with a learning unit 230 (a registration unit). To distinguish from the first embodiment, the controller of the information processing device 2 will be referred to as a “controller 20”.

The learning unit 230 registers the iris code and pupil dilation R acquired by the analysis unit 120 in the authentication DB 91 in accordance with the verification result from the verification unit 140. More specifically, when the object H is successfully authenticated by the verification unit 140 (i.e., when the above-described coincidence is determined to be within the prescribed range), the learning unit 230 registers the iris code and pupil dilation R used in the verification by the verification unit 140 as a registered iris code and a registered pupil dilation, respectively. Thus, the learning unit 230 is a function unit that adds, to the registration unit 130, a function for registering the registered iris code and the registered pupil dilation in accordance with the verification result from the verification unit 140.

By providing the information processing device 2 with the learning unit 230, the registered iris code and the registered pupil dilation are added to the authentication DB 91 each time the verification by the verification unit 140 succeeds. In a case where, in the information processing device 2, at least one first image IMG1 is acquired in advance and the registered pupil dilation and registered iris code corresponding to that first image IMG1 (second image IMG2) are recorded in the authentication DB 91 in advance, the information processing device 2 can carry out authentication. In other words, it is sufficient for at least one set of a registered iris code and a registered pupil dilation to be registered in the authentication DB 91 for the initial instance of authentication. The registered iris code and registered pupil dilation may be registered through the processing carried out during registration, described in the first embodiment.

In other words, it is not necessary to acquire many (and more specifically, two or more) first images IMG1 (first images IMG1 having different pupil dilations R) in advance and record the registered pupil dilation and registered iris code corresponding to each first image IMG1 (second image IMG2) in the authentication DB 91 in advance. Accordingly, the amount of data to be registered in the authentication DB 91 for the initial authentication can be reduced. Thus, it is possible lighten the burden on the users (the registrants) when creating the authentication DB 91.

Furthermore, by providing the learning unit 230, the number of sets of registered iris codes and registered pupil dilations (registered data pairs) can be increased as the number of successful verifications (the number of times verification has succeeded) increases. Thus, it is possible to further increase the accuracy of the verification by the verification unit 140.

However, it is preferable not to register all of the data for which the verification by the verification unit 140 has succeeded (preferable not to have an extremely high number of registered data pairs), for the following two reasons:

(i) in a case where there is an extremely high number of registered data pairs, the verification process by the verification unit 140 will take longer; and
(ii) an extremely high number of registered data pairs takes up more storage space in the storage 90.

It is thus preferable that the number of registered data pairs be limited. In other words, it is preferable that an upper limit value be set for the number of registered iris codes and registered pupil dilations that can be registered in the authentication DB 91 of the storage 90. As an example, it is preferable that the learning unit 230 record up to a prescribed number (e.g., 100), serving as the upper limit value, of the registered data pairs in the authentication DB 91, in accordance with the verification results from the verification unit 140.

From the standpoint of improving the verification accuracy, it is preferable that the pupil dilations R (registered pupil dilations) registered by the learning unit 230 have as uniform a distribution as possible within a prescribed numerical value range.

As an example, consider a case where the pupil dilation R is calculated as R=D1/D2, as in the first embodiment. For the eyeball HE of a typical person, it is known that generally, 2 mm≤D1≤6 mm and D2≈12 mm.

Using the above values for D1 and D2, a rough calculation of 0.16 (=⅙)≤R≤0.5 (=½) can be made. Thus, in a case where a slight margin is factored in, the pupil dilation R can generally be expected to be distributed throughout a range of 0.1≤R≤0.7.

Accordingly, it is preferable that the pupil dilations R be registered as the registered pupil dilations by the learning unit 230 such that the registered pupil dilations are distributed as uniformly as possible throughout the range of 0.1 R≤0.7.

The learning unit 230 may therefore determine whether to register a newly-obtained pupil dilation R (“Rnew” hereinafter) on the basis of the distribution of the pupil dilations R acquired up to that point.

For example, in a case where the pupil dilation Rnew is within a numerical value range of the mode of the pupil dilations R acquired up to that point, the learning unit 230 does not record that pupil dilation Rnew in the authentication DB 91. Note that the “mode” is the maximum value of the number of pupil dilations R registered. Also, the “numerical value range of the mode of the pupil dilations R” refers to a prescribed range of the pupil dilations R including the mode of the pupil dilations R. In a case where, for example, the prescribed range is set to the pupil dilation R indicating the mode±0.05, and the number of registrations where R=0.35 is the maximum, a range of 0.3≤R≤0.4 corresponds to the stated numerical value range.

Even in a case where the total registered number of registered iris codes and registered pupil dilations has reached the upper limit value, the learning unit 230 may, in a case where a prescribed condition is met, delete one of the registered data pairs already registered and then register the pupil dilation Rnew, along with the iris code corresponding to that pupil dilation Rnew, in the authentication DB 91. In other words, the learning unit 230 may have a function for overwriting registered data pairs. In this case, the learning unit 230 carries out the following processing, for example.

First, the learning unit 230 determines whether there is bias in the above-described distribution. The learning unit 230 can determine whether there is bias in the above-described distribution by determining, for example, whether there is a pupil dilation R exceeding a prescribed number of registrations. In a case where the learning unit 230 determines that there is bias in the above-described distribution, the learning unit 230 then determines whether the pupil dilation Rnew is present in a prescribed range of pupil dilations R including the pupil dilation R exceeding the prescribed number of registrations. In a case where the learning unit 230 then determines that the pupil dilation Rnew is not present in the prescribed range of pupil dilations R, the learning unit 230 deletes the registered data pair including one of the pupil dilations R in the prescribed range of pupil dilations R and registers, in its place, the pupil dilation Rnew and the iris code corresponding to that pupil dilation Rnew as a new registered data pair.

The prescribed number of registrations is an indicator for determining whether there is bias in the distribution, and is set for each pupil dilation R, for example. In other words, the prescribed number of registrations is any desired threshold less than the upper limit value for the total number of registrations.

On the other hand, in a case where (i) there is no bias in the distribution or (ii) there is bias but the pupil dilation Rnew is present in the prescribed range of pupil dilations R, the learning unit 230 does not register the pupil dilation Rnew and the iris data generated at the time of calculating the pupil dilation Rnew.

Also, in a case where a registered data pair is to be overwritten, the registered data pair to be deleted may be selected in the following manner. For example, past verification results (the calculated Hamming distance Hd, or a verification performance) are stored in the authentication DB 91 for each registered data pair. In a case where the learning unit 230 determines that there is a registered data pair in relation to a verification result having poor verification performance or a relatively high Hamming distance Hd, the learning unit 230 selects that registered data pair to be deleted. The learning unit 230 then registers a new registered data pair in the authentication DB 91 in place of the deleted registered data pair. The quality of the verification performance may be determined by comparison with a Hamming distance Hd (threshold) set in advance. Whether the Hamming distance Hd is relatively high may also be determined by comparison with that threshold.

### Processing by Information Processing Device 2

An example of a processing method (authentication method) carried out by the information processing device 2 will be described with reference to FIG. 7. FIG. 7 is a flowchart illustrating an example of the processing method carried out by the information processing device 2. Note that FIG. 7 is also a flowchart illustrating an example of a processing method (authentication method) carried out by an information processing device 3 according to the third embodiment.

The information processing device 2 carries out the processes of steps S1 to S4, S11, and S12, in the same manner as when the authentication is carried out in the first embodiment.

After step S11, the verification unit 140 determines whether the authentication has succeeded (step S21). As described in the first embodiment, in a case where the Hamming distance Hd is less than or equal to the Hamming distance threshold Hdth, the verification unit 140 determines that the iris authentication has succeeded for the object H. In other words, in a case where the verification unit 140 can determine that the iris code acquired during authentication has a value similar to a registered iris code, the verification unit 140 determines that the authentication is successful even when the acquired iris code does not match a registered iris code.

In a case where the verification unit 140 determines that the authentication has succeeded (YES in step S21), the learning unit 230 determines whether the authentication DB 91 does not contain a registered data pair matching the iris code and pupil dilation R acquired during authentication (whether the data pair is not yet registered) (step S22). In a case where the learning unit 230 determines that the data pair is not yet registered (YES in step S22), the learning unit 230 determines whether the current number of registered data pairs is less than or equal to the upper limit value (step S23). In a case where the learning unit 230 determines that the number of registered data pairs is less than or equal to the upper limit value (YES in step S23), the learning unit 230 registers the acquired iris code and pupil dilation R in the authentication DB 91 as a registered iris code and a registered pupil dilation (step S5).

Additionally, the verification unit 140 outputs an authentication result (S12). After the process of S5, the verification unit 140 announces that the authentication has succeeded. Further, even in a case where the acquired iris code and pupil dilation R are registered in the authentication DB 91 (NO in step S22), or the number of registered data pairs in the authentication DB 91 exceeds the upper limit value (NO in step S23), the verification unit 140 announces that the authentication has succeeded. On the other hand, in a case where the authentication has failed (NO in step S21), the verification unit 140 announces that the authentication has failed.

Note that the process of step S12 may be carried out immediately after the process of step S21. The order of steps S22 and S23 may be reversed, or the processes thereof may be carried out in parallel. Additionally, the learning unit 230 may determine whether to register the pupil dilation R acquired during authentication (the pupil dilation Rnew) and the iris code corresponding to that pupil dilation R in the authentication DB 91 on the basis of the distribution of the pupil dilations R as described above, after step S23, for example. The process of step S23 may be omitted in a case where the number of registered data pairs becoming extremely high is not to be factored in as described above.

Note that the information processing device 2 may be provided with a function for recursively repeating the authentication (a function for retrying the authentication) when the authentication fails in step S21. In other words, in a case where the authentication in step S21 fails, the process may return to step S1 to carry out the image capturing and authentication again before the authentication result is output (announced) in step S12. In a case where the authentication fails again in step S21, the process may once again return to step S1, and the image capturing and authentication may be repeated.

From the perspective of shortening the authentication time, it is preferable that the number of retries (the number of recursive authentications) be limited. In a case where the authentication fails in step S21 after the number of retries has reached the limit number, the verification unit 140 outputs the authentication result, indicating that the authentication has failed, in step S12. The function for retrying the authentication and the number of retries may also be applied in the information processing device 1 of the first embodiment.

The foregoing describes an example in which authentication is carried out having captured a single image (a still image). However, a moving image may be captured and the authentication may be carried out on a frame constituting the moving image. In other words, the authentication can also be carried out using a moving image (video authentication).

In the case of video authentication, a plurality of images (frames) may be acquired in a short amount of time by capturing a moving image, and thus the authentication may be advanced while continuing the image capturing step, at the same timing as the image capturing step in order of the images captured. In this case, the image acquisition (video capturing) may be stopped, and the verification unit 140 may be caused to output the authentication result at a point in time when the authentication has succeeded.

Note that the verification unit 140 may be caused to output an authentication result indicating the authentication has failed in a case where the authentication has not succeeded for any of the plurality of images (frames) acquired in a prescribed image capturing time. Such video authentication may also be applied in the information processing device 1 of the first embodiment.

As described thus far, by including the learning unit 230, the information processing device 2 realizes a learning function, in which an acquired iris code and pupil dilation R are registered as a registered iris code and a registered pupil dilation in a case where the authentication succeeds. Thus, with the information processing device 2, the amount of data registered can be increased using the learning function. The accuracy of authentication can be improved with each instance of authentication, even without, for example, intentionally registering many pupil dilations and iris codes corresponding to those pupil dilations prior to authentication in order to reduce the influence of the intensity of ambient light. Thus, according to the information processing device 2, it is not necessary to register any more data than is necessary, which increases the convenience for the user.

### Third Embodiment

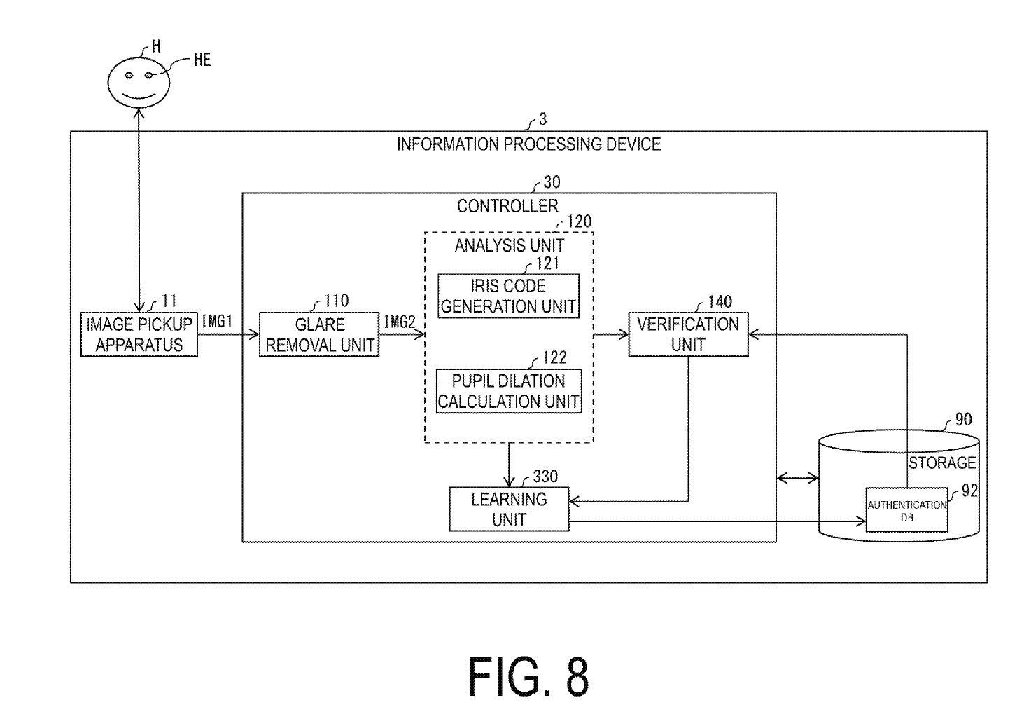

The third embodiment will be described with reference to FIGS. 7 to 9B. FIG. 8 is a function block diagram illustrating a primary configuration of an information processing device 3 (an authentication device) according to the third embodiment. The present embodiment also considers a case where the pupil dilation R is calculated as R=D1/D2, as in the first embodiment, as an example.

### Configuration of Information Processing Device 3

As illustrated in FIG. 8, the information processing device 3 has a configuration in which, in the information processing device 2 of the second embodiment, (i) the learning unit 230 is replaced with a learning unit 330 (a registration unit) and (ii) the authentication DB 91 is replaced with an authentication DB 92. To distinguish from the second embodiment, the controller of the information processing device 3 is referred to as a “controller 30”.

In the authentication DB 92, the registered iris code and registered pupil dilation of each registrant are recorded in a different data structure (format) than in the authentication DB 91. Specifically, in the authentication DB 92, the registered iris code and registered pupil dilation of each registrant are registered with classes provided for the pupil dilation (with the pupil dilations classified by numerical value ranges). In other words, in the authentication DB 92, a plurality of classes are provided in accordance with the pupil dilation values.

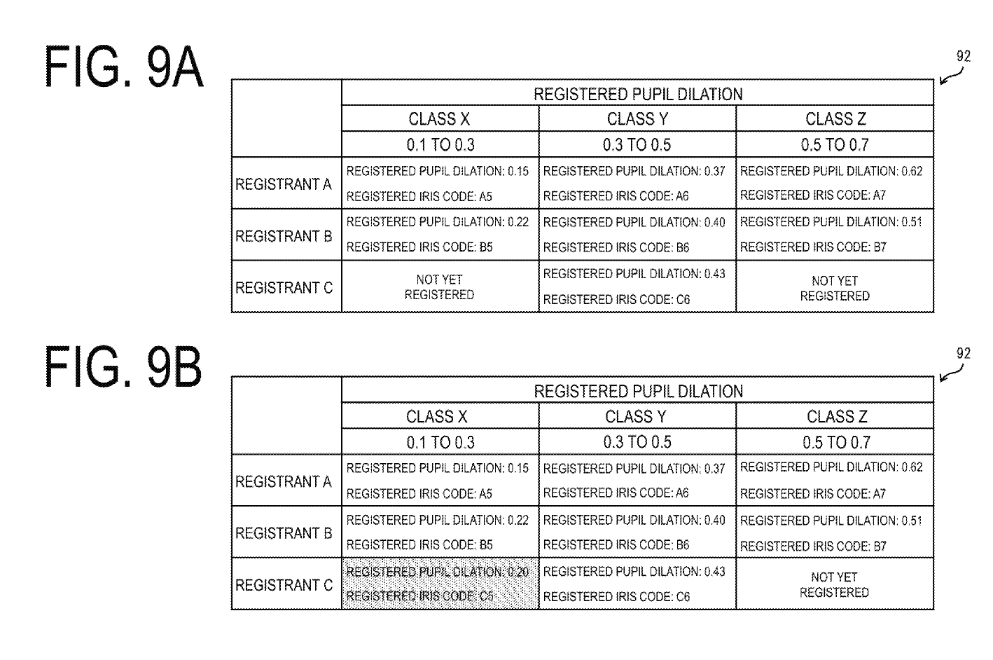

FIGS. 9A and 9B are diagrams illustrating an example of data in the authentication DB 92. FIGS. 9A and 9B illustrate an example in which three people, namely registrants A to C, serve as registrants. As illustrated in FIGS. 9A and 9B, in the authentication DB 92, the pupil dilations are divided into three classes X to Z. Class X is a range of 0.1≤R≤0.3. Class Y is a range of 0.3≤R≤0.5. Class Z is a range of 0.5≤R≤0.7.

However, the number of classes can be set as desired, and is not limited to three. As an example, there may be two classes, or four or more classes. Likewise, the numerical value ranges of the pupil dilation corresponding to the classes are not limited to the above examples. However, it is preferable that the classes be set such that the registered pupil dilations are distributed as uniformly as possible, for the same reasons as described in the second embodiment.

FIG. 9A illustrates an example of data prior to the learning unit 330 carrying out recording in accordance with the newly-acquired pupil dilation Rnew. In the example of FIG. 9A, registered iris codes for registrants A to C, are respectively assigned one to each class (and more specifically, to a registered pupil dilation in each class). For the sake of simplicity, for registrant A, the registered iris code in class X will be referred to as A5; the registered iris code in class Y will be referred to as A6; and the registered iris code in class Z will be referred to as A7. Likewise, for registrant B, the registered iris code in class X will be referred to as B5; the registered iris code in class Y will be referred to as B6; and the registered iris code in class Z will be referred to as B7. For registrant A and registrant B, a pupil dilation R is registered for each of the classes X to Z.

Meanwhile, for registrant C, the registered iris code in class Y will be referred to as C6. In the example of FIG. 9A, registrant C has neither a pupil dilation R, nor a registered iris code corresponding to that pupil dilation R, registered in classes X and Z. In the following descriptions, the iris code in class X that is newly registered by the learning unit 330 will be referred to as C5.

The learning unit 330 registers an iris code and a pupil dilation R for each of the classes X to Z defined in the authentication DB 92. As an example, consider a case where registrant C is authenticated by the verification unit 140. Here, assume that the pupil dilation Rnew acquired on the basis of an image captured of the registrant C is 0.20 (a value belonging to class X), and the iris code is “C5”.

In this case, the acquired pupil dilation Rnew is 0.20, and thus the verification unit 140 verifies the acquired iris code “C5” against the registered iris codes in class X. In FIG. 9A, the acquired iris code “C5” differs from the iris codes of registrants A and B (“A5” and “B5”), and is not yet registered for registrant C. Thus, as a next step in the verification, the verification unit 140 verifies the iris code “C5” against the registered iris code in the class adjacent to the class X, namely class Y (a class near the pupil dilation Rnew). The registered iris code “C6” for registrant C is present in class Y, and thus the verification unit 140 verifies the iris code “C5” against the registered iris code “C6”. In a case where the verification result indicates that the calculated Hamming distance Hd is less than or equal to the prescribed Hamming distance threshold Hdth, the authentication of registrant C succeeds. Consider a case where the iris code “C5” acquired during authentication is verified against the registered iris code “C6” and the authentication has succeeded as a result. Note that in a case where a registered data pair is present in class X for registrant C, the verification unit 140 verifies the acquired iris code against the registered iris code in that registered data pair.

In FIG. 9A, the pupil dilation Rnew (0.20) is a value that is somewhat distant from the registered pupil dilation in class Y (0.43), but it should be noted that even in such a case, the authentication of registrant C has a certain probability of succeeding.

However, generally speaking, the probability of the authentication of registrant C succeeding (an authentication success rate) tends to be higher the closer the value of the pupil dilation Rnew is to the registered pupil dilation in class Y. In other words, the probability of the authentication of registrant C failing (an authentication failure rate) tends to be higher the further the value of the pupil dilation Rnew is from the registered pupil dilation in class Y. The authentication failure rate is also referred to as a “personal rejection rate”.

FIG. 9B illustrates an example of data after the learning unit 330 carries out recording in accordance with the pupil dilation Rnew. In the authentication of registrant C corresponding to the iris code “C5”, the pupil dilation Rnew is 0.20, and thus the learning unit 330 determines that the pupil dilation Rnew belongs to class X.

As a result, the learning unit 330 registers the pupil dilation Rnew as the registered pupil dilation in class X. The learning unit 330 also registers the iris code “C5” as the registered iris code in class X.

Note that the learning unit 330 may register a plurality of registered data pairs in each class. In this case, in a case where the pupil dilation Rnew and the iris code corresponding to that pupil dilation Rnew do not match a registered data pair belonging to the class having the numerical value range that includes the pupil dilation Rnew, that data is determined to be not yet registered in that class and is therefore data to be registered in that class. In a case where the number of registered data pairs becoming extremely high is to be factored in as described above, an upper limit value may be provided for the number of registered data pairs that can be registered in each class.

### Processing by Information Processing Device 3

An example of a processing method carried out by the information processing device 3 will be described next with reference to FIG. 7. Only processing methods different from the processing method of the information processing device 2 will be described here.

In step S11, the verification unit 140 identifies which of the classes X to Z the acquired pupil dilation Rnew corresponds to, and verifies the iris code corresponding to the pupil dilation Rnew against the registered iris code in the identified class (class X, in the example in FIGS. 9A and 9B). In a case where a registered data pair is present in that class, the verification unit 140 carries out the verification with that registered data pair. In a case where the verification in that class has failed, the verification unit 140 carries out the verification with the class adjacent to that class (class Y, in the example of FIGS. 9A and 9B).

In a case where the authentication of the registrant by the verification unit 140 has succeeded (YES in step S21), the learning unit 330 determines whether the pupil dilation Rnew and an iris code corresponding to the pupil dilation Rnew are not yet registered in the class having a numerical value range that includes the value of the pupil dilation Rnew (class X, in the example of FIGS. 9A and 9B) (step S22). Note that in a case where the authentication has failed in all classes X to Z (NO in step S21), the process proceeds to step S12.

In a case where the pupil dilation Rnew and the iris code corresponding to the pupil dilation Rnew are not yet registered (YES in step S22), the learning unit 330 determines whether the number of registered data pairs in that class is less than or equal to an upper limit value (step S23). In a case where the number of registered data pairs is less than or equal to the upper limit value (YES in step S23), the learning unit 330 registers the pupil dilation Rnew and the iris code corresponding to the pupil dilation Rnew as the registered iris code and the registered pupil dilation (step S5).

Thus, in a case where the authentication by the verification unit 140 is determined to have succeeded, the learning unit 330 can register the pupil dilation Rnew as the registered pupil dilation in one of a plurality of classes set in the authentication DB 92 (specifically, in a class having a numerical value range that includes the value of the pupil dilation Rnew). The verification unit 140 identifies the class used for the verification, among the plurality of classes that are set, on the basis of the acquired pupil dilation Rnew, and carries out the verification using the registered iris codes belonging to that class. In other words, rather than extracting all of the registered data pairs as targets for verification, the verification unit 140 can limit the targets for verification according to class, and extract the corresponding registered data pairs. For example, the verification unit 140 can use only the data (e.g., the registered iris codes) corresponding to one of the provided classes (e.g., one of the classes X to Z in FIGS. 9A and 9B) as targets for verification. This makes it possible to further shorten the time required for verification.

Like the learning unit 230 of the second embodiment, in a case where the registered iris codes and registered pupil dilations have reached upper limit values, the learning unit 330 may delete a registered data pair that meets a prescribed condition and register a new registered data pair in the authentication DB 92.

### Fourth Embodiment

Control blocks (in particular, the controllers 10 to 30) of the information processing devices 1 to 3 may be realized by logic circuits (hardware) formed in an integrated circuit (IC chip) or the like, or by software by using Central Processing Unit (CPU).

In the latter case, each of the information processing devices 1 to 3 includes a CPU for executing instructions of a program which is software for realizing each function, Read-Only Memory (ROM) or a storage device (both referred to as “recording medium”) in which the program and various types of data are recorded in a computer-readable (or CPU-readable) manner, Random Access Memory (RAM) in which the program is loaded, and the like. Then, the computer (or CPU) reads the program from the recording medium and executes the program to achieve the object of the present disclosure. A “non-transitory tangible medium”, such as tape, a disk, a card, semiconductor memory, or a programmable logic circuit, may be used as the recording medium. Further, the program may be supplied to the computer via any transmission medium (a communication network, a broadcast wave, or the like) able to transmit the program. Note that an embodiment of the present disclosure may be realized in the form of a data signal embedded in a carrier wave, which is embodied by electronic transmission of the program.

### SUPPLEMENT

An authentication device according to a first aspect of the present disclosure (the information processing devices 1, 2, and 3) includes: an image information acquiring unit (the image pickup apparatus 11) configured to acquire image information (the first image IMG1) of an object (H) including an eyeball (HE); a regularly-reflected light component removal unit (the glare removal unit 110) configured to remove at least part of a regularly-reflected light component of the eyeball from the image information; an iris code generation unit (121) configured to generate an iris code; and a pupil dilation calculation unit (122) configured to calculate a pupil dilation indicating a degree of dilation of a pupil (HPP). Here, (i) the iris code generation unit generates the iris code, based on post-removal image information obtained by removing at least a part of the regularly-reflected light component, and the pupil dilation calculation unit calculates the pupil dilation, based on the post-removal image information; or (ii) the iris code generation unit generates the iris code, based on the post-removal image information, and the pupil dilation calculation unit calculates the pupil dilation, based on the image information; or (iii) the iris code generation unit generates the iris code, based on the image information, and the pupil dilation calculation unit calculates the pupil dilation, based on the post-removal image information.

According to this configuration, the process of at least one of generating the iris code and calculating the pupil dilation is carried out on the basis of the post-removal image information obtained by removing at least a part of the regularly-reflected light component from the image information. In other words, the process of at least one of generating the iris code and calculating the pupil dilation is carried out on the basis of the post-removal image information, in which the effects of glare from ambient light on the iris have been reduced. Accordingly, at least one of an iris code and a pupil dilation in which these effects are reduced can be used in the iris authentication. In other words, iris authentication in which the effects of glare from ambient light on the iris are reduced can be carried out.

Furthermore, by using the pupil dilation along with the iris code in the iris authentication, iris authentication in which the effects of changes in the intensity of ambient light are reduced can be carried out.

Thus, according to the authentication device, the occurrence of authentication errors can be reduced. In other words, according to the authentication device, the iris authentication can be carried out accurately.

Furthermore, according to an authentication device according to a second aspect of the present disclosure, the above-described first aspect may further include a registration unit (130, the learning units 230 and 330) configured to relate the iris code generated by the iris code generation unit and the pupil dilation calculated by the pupil dilation calculation unit, and register the iris code and the pupil dilation in a storage (90) as a registered iris code and a registered pupil dilation, respectively.

According to this configuration, the iris authentication can be carried out using the iris code and/or the pupil dilation based on the post-removal image information, in which the effects of glare from ambient light on the iris have been reduced.

Furthermore, the iris code and the pupil dilation are registered (accumulated), and thus it is not necessary to carry out processing equivalent to glare removal for that registration each time authentic is carried out in order to realize accurate iris authentication. This makes it possible to shorten the time required for authentication.

Furthermore, according to an authentication device according to a third aspect of the present disclosure, the above-described second aspect may further include a verification unit (140) configured to verify the iris code and the pupil dilation against the registered iris code and the registered pupil dilation that are already registered.

According to this configuration, the iris authentication can be carried out using the iris code and/or pupil dilation based on the post-removal image information. This makes it possible to reduce the occurrence of authentication errors.

Furthermore, according to an authentication device according to a fourth aspect of the present disclosure, in the above-described third aspect, the verification unit may verify the iris code against the registered iris codes in order from the registered pupil dilation, among the registered pupil dilations, that has a value closest to a value of the pupil dilation.

According to this configuration, the time required for verification can be shortened compared to a case where the acquired iris data is verified randomly against a plurality of registered iris codes.

Furthermore, according to an authentication device according to a fifth aspect of the present disclosure, in the above-described third or fourth aspects, in the case where the verification unit determines that a coincidence between the iris code and the registered iris code is within a prescribed range, the registration unit may register the iris code and the pupil dilation from when the iris code was calculated as the registered iris code and the registered pupil dilation, respectively.

According to this configuration, the registered iris code and the registered pupil dilation are registered in the case where the above-described determination has been made. This makes it possible to register only an iris code and a pupil dilation of the actual subject as the registered iris code and the registered pupil dilation. This also makes it possible to realize a learning function in the registration unit, in which the registration is carried out in this manner.

Furthermore, according to an authentication device according to a sixth aspect of the present disclosure, in the above-described fifth aspect, an upper limit value may be set for a number of sets of the registered iris code and the registered pupil dilation that can be registered in the storage.

The more registered iris codes and registered pupil dilations there are, the more likely it is that the authentication will take a correspondingly longer time. According to this configuration, the number of sets of the registered iris code and the registered pupil dilation that can be registered in the storage can be limited. This makes it possible to avoid a situation in which an excessive amount of information causing an increase in the time required for authentication. This limitation also makes it possible to make effective use of the storage space in the storage.

Furthermore, according to an authentication device according to a seventh aspect of the present disclosure, in the above-described fifth or sixth aspects, a plurality of classes (X, Y, and Z) may be set in accordance with values of the pupil dilation; and the registration unit may register the pupil dilation calculated by the pupil dilation calculation unit as the registered pupil dilation in one of the plurality of classes.

According to this configuration, the pupil dilation is registered in one of the plurality of classes that are set, and thus during registration, a class can be selected first in accordance with the value of the calculated pupil dilation. In other words, during verification, the target of verification can be narrowed down greatly. This makes it possible to shorten the time required for authentication.

Furthermore, an authentication method according to an eighth aspect of the present disclosure includes the steps of: acquiring image information of an object including an eyeball; removing at least part of a regularly-reflected light component of the eyeball from the image information; generating an iris code; and calculating a pupil dilation indicating a degree of dilation of a pupil. Here, (i) in the step of generating an iris code, the iris code is generated, based on post-removal image information obtained by removing at least a part of the regularly-reflected light component, and in the step of calculating a pupil dilation, the pupil dilation is calculated, based on the post-removal image information; or (ii) in the step of generating an iris code, the iris code is generated, based on the post-removal image information, and in the step of calculating a pupil dilation, the pupil dilation is calculated, based on the image information; or (iii) in the step of generating an iris code, the iris code is generated, based on the image information, and in the step of calculating a pupil dilation, the pupil dilation is calculated, based on the post-removal image information.

According to this method, the iris authentication can be carried out accurately, in the same manner as with the first aspect.

The authentication device according to each aspect of the present disclosure may be realized by a computer. In this case, an authentication control program for the authentication device which realizes the authentication device in the computer by causing the computer to function as each unit (software module) included in the authentication device, and a computer-readable recording medium storing the authentication control program, also fall within the scope of the disclosure.

### ADDITIONAL NOTES

Embodiments of the present disclosure are not limited to the above-described embodiments. Various modifications can be made within the scope of the claims. An embodiment obtained by appropriately combining technical elements each disclosed in different embodiments also falls within the technical scope of the disclosure. Furthermore, technical elements disclosed in the respective embodiments may be combined to provide a new technical feature.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An authentication device comprising:
an image information acquiring unit configured to acquire image information of an object including an eyeball;
a regularly-reflected light component removal unit configured to remove at least part of a regularly-reflected light component of the eyeball from the image information;
an iris code generation unit configured to generate an iris code; and
a pupil dilation calculation unit configured to calculate a pupil dilation indicating a degree of dilation of a pupil, wherein
(i) the iris code generation unit generates the iris code, based on post-removal image information obtained by removing at least a part of the regularly-reflected light component, and the pupil dilation calculation unit calculates the pupil dilation, based on the post-removal image information, or
(ii) the iris code generation unit generates the iris code, based on the post-removal image information, and the pupil dilation calculation unit calculates the pupil dilation, based on the image information; or
(iii) the iris code creation unit generates the iris code, based on the image information, and the pupil dilation calculation unit calculates the pupil dilation, based on the post-removal image information.

2. The authentication device according to claim 1, further comprising a registration unit configured to relate the iris code generated by the iris code generation unit and the pupil dilation calculated by the pupil dilation calculation unit, and register the iris code and the pupil dilation in a storage as a registered iris code and a registered pupil dilation, respectively.

3. The authentication device according to claim 2, further comprising a verification unit configured to verify the iris code and the pupil dilation against the registered iris code and the registered pupil dilation that are already registered.

4. The authentication device according to claim 3, wherein the verification unit verifies the iris code against the registered iris codes in order from the registered pupil dilation that has a value closest to a value of the pupil dilation.

5. The authentication device according to claim 3, wherein in the case where the verification unit determines that a coincidence between the iris code and the registered iris code is within a prescribed range, the registration unit registers the iris code and the pupil dilation from when the iris code was calculated as the registered iris code and the registered pupil dilation, respectively.

6. The authentication device according to claim 4, wherein in the case where the verification unit determines that a coincidence between the iris code and the registered iris code is within a prescribed range, the registration unit registers the iris code and the pupil dilation from when the iris code was calculated as the registered iris code and the registered pupil dilation, respectively.

7. The authentication device according to claim 5, wherein an upper limit value is set for a number of sets of the registered iris code and the registered pupil dilation that can be registered in the storage.

8. The authentication device according to claim 6, wherein an upper limit value is set for a number of sets of the registered iris code and the registered pupil dilation that can be registered in the storage.

9. The authentication device according to claim 5,
wherein a plurality of classes are set in accordance with values of the pupil dilation; and
the registration unit registers the pupil dilation calculated by the pupil dilation calculation unit as the registered pupil dilation in one of the plurality of classes.

10. The authentication device according to claim 6,
wherein a plurality of classes are set in accordance with values of the pupil dilation; and
the registration unit registers the pupil dilation calculated by the pupil dilation calculation unit as the registered pupil dilation in one of the plurality of classes.

11. The authentication device according to claim 7,
wherein a plurality of classes are set in accordance with values of the pupil dilation; and
the registration unit registers the pupil dilation calculated by the pupil dilation calculation unit as the registered pupil dilation in one of the plurality of classes.

12. The authentication device according to claim 8,
wherein a plurality of classes are set in accordance with values of the pupil dilation; and
the registration unit registers the pupil dilation calculated by the pupil dilation calculation unit as the registered pupil dilation in one of the plurality of classes.

13. An authentication method comprising the steps of:
acquiring image information of an object including an eyeball;
removing at least part of a regularly-reflected light component of the eyeball from the image information;
generating an iris code; and
calculating a pupil dilation indicating a degree of dilation of a pupil, wherein
(i) in the step of generating an iris code, the iris code is generated, based on post-removal image information obtained by removing at least a part of the regularly-reflected light component, and in the step of calculating a pupil dilation, the pupil dilation is calculated, based on the post-removal image information, or
(ii) in the step of generating an iris code, the iris code is generated, based on the post-removal image information, and in the step of calculating a pupil dilation, the pupil dilation is calculated, based on the image information, or
(iii) in the step of generating an iris code, the iris code is generated, based on the image information, and in the step of calculating a pupil dilation, the pupil dilation is calculated, based on the post-removal image information.
